(19) United States
(12) Patent Application Publication
(10) Pub. No.: US 2010/0066584 A1
(43) Pub. Date: Mar. 18, 2010

(54) Interface for Remote Controllers

(76) Inventor: Clifton Forlines, West Newton, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/211,901

(22) Filed: Sep. 17, 2008

(51) Int. Cl. H04L 17/02

(52) U.S. Cl. 341/176

(57) ABSTRACT

An apparatus and method interfaces consumer devices and wireless remote controllers. A remote controller interface is configured to sense and process wireless control signals received from a set of secondary remote controllers associated with a set of secondary consumer devices. There is one secondary remote controller for each secondary consumer device. The interface is configured to enable input from any of the secondary consumer devices to the primary consumer device in response to sensing the wireless control signals.

### FIELD OF THE INVENTION

This invention relates generally to remote controllers, and more particularly to an interface for different wireless remote controllers for a consumer device.

### BACKGROUND OF THE INVENTION

In a conventional home entertainment center, a large number of consumer devices can be operated by remote controllers, e.g., TVs, DVDs, VCRs, CDs, games, set-top boxes, and other appliances. Most remote controllers are wireless and emit infrared (IR) signals. Remote controllers for different devices usually have different sets of commands and different arrangements of buttons. Managing all these different remote controllers is cumbersome. For example, to play a movie, the user has to operate both the television and DVD remote controller.

One solution is a universal remote controller. However, it is difficult to provide the required functionalities in a single remote controller. Often, the number of buttons is insufficient or very large, or certain functions require an unacceptably complicated key sequence or modal states to access and execute remote controller commands. Universal remote controllers with a large number of keys are difficult to operate. Frequently, there is a mismatch between on-screen interfaces and the buttons on the universal remote controller.

Another issue is that most televisions have a small number input ports for connecting to other consumer devices. This makes it difficult to connect many devices to the television at the same type. The current solutions may involve serially daisy-chaining, using some type of switch or an audio-video receiver (AVR). The primary purpose of the AVR is to amplify sound from a multitude of possible audio sources, as well as route video signals from various sources to the television. Typically, AVRs need to be programmer by the consumer. Cable incompatible can also be an issue when connecting many consumer devices.

### SUMMARY OF THE INVENTION

An apparatus and method interfaces consumer devices and wireless remote controllers. A remote controller interface is configured to sense and process wireless control signals received from a set of secondary remote controllers associated with a set of secondary consumer devices. There is one secondary remote controller for each secondary consumer device. The interface is configured to enable input from any of the secondary consumer devices to the primary consumer device in response to sensing the wireless control signals.

### BRIEF DESCRIPTION OF THE DRAWINGS

FIG. 1 is a block diagram of a remote controller interface according to embodiments of the invention;

FIG. 2 is a block diagram of a remote controller according to an embodiment of the invention; and

FIG. 3 is a flow diagram of a method for interface remote controllers.

### DETAILED DESCRIPTION OF THE PREFERRED EMBODIMENTS

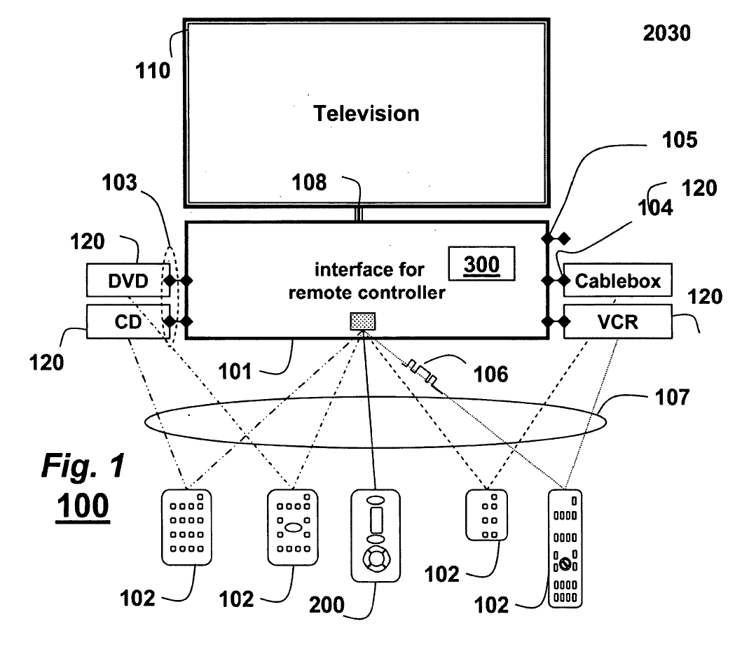

As shown in FIG. 1, a home entertainment center 100 according to the embodiments of the invention includes an apparatus 101 and method 300 for interfacing to different remote controllers. A remote controller interface 101 can be embedded in a primary consumer device 110, e.g., a television, or a standalone device connected to primary consumer device. The interface is configured to sense and process control signals 107 from a number of different secondary remote controllers 102 that are used to operate a set of secondary consumer devices 120, e.g., DVD, CD, VCR, PC and cablebox. There is one secondary remote controller for each secondary consumer device. Each remote controller is capable of emitting a set of control signals 106. Generally, the secondary consumer devices can be called multimedia playback devices.

Typically, the interface is connected to all of the secondary devices by cables, e.g., coaxial, optical fiber or some local wireless connections, at input ports 103 to the primary device, as described below in detail. However, at any one time only a single input port is enabled. One object of the invention is to simplify which devices are enabled for input. In addition, the connection between the interface and the primary device can be a single cable 108, which makes it a lot easier to switch the primary device than in conventional home entertainment centers.

The control signals sensed by the interface are processed to operate the primary and secondary devices. Typically, the control signals are wireless signals, such as infrared (IR) and radio frequency (RF) signals. For IR signals, the control signals are typically modulated at a carrier frequency of 38 or 40 kHz. The binary pulses 106 are pulse, space or shift encoded, e.g., REC-80 or RC-5. The control signals include an address that specifies the target device, and a command. The control signals for most consumer devices are readily available. It is understood that the control signals for different devices are unique for the devices. That is the remote controller use different encodings, and the remote controller for one device typically cannot be used to operate another device. That is, the remote controllers are incompatible with each other.

The problem is not the number of remote controllers required to perform different tasks, but the number of remote controllers to perform a single task. Instead of trying to construct a universal remote controller that controllers all of the devices 120 and the television 110 as in the prior art, the idea of the invention is to sense and process the remote controller control signals 107 from any remote controller 102.

This way, the secondary devices perform the functions corresponding to the commands, and the primary performs the necessary operations to support the function of the secondary devices, such controlling power, volume and connecting the appropriate input ports 103 and output ports 104.

The remote controller interface 101 is configured to learn, sense, and process control signals from any of the secondary remote controllers for any of the secondary consumer devices. The interface 101 can also sense the presence or absence of data or control signals at any of the input or output ports. The data signals can include audio and video signals. The control signals can be specific for the various secondary devices. The ports can be assigned or unassigned, e.g., port 105, i.e., no secondary device is connected and active. The adding of secondary devices and assigning ports is described in greater detail below.

A Minimal Remote Control

Remote Controller

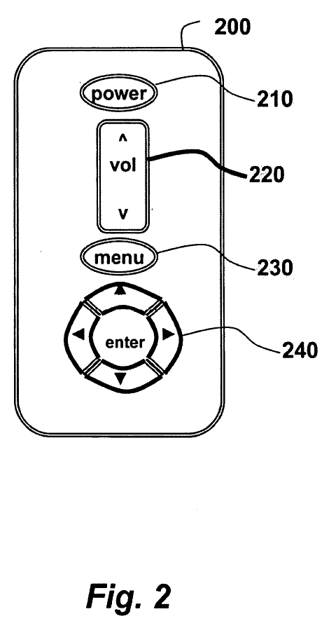

FIG. 2 shows an example minimal remote controller 200 according to embodiments of the invention. The remote controller 200 can be used to operate the primary device, i.e., the remote controller 200 is a primary remote controller.

Power

The remote controller 200 includes at least a power button 210. Pushing the power button turns on the interface and the appropriate devices. The secondary devices at this point can generate a video and/or audio signal. The signal can be sensed at the input port 103 of the primary device. In response, the interface turns on the primary device. Turning the power off on the secondary device using the remote controller has the opposite effect, and the primary device is also turned off.

Volume

The minimal remote controller 200 also includes a volume button 220. The volume button controls the volume of the audio signals input from any consumer device.

Menu

A menu button is used to set-up, configure and control on-screen displays for the interface and the controllers.

Menu Control

The menu is operated by the menu control buttons 240, which include up, down, left, right and enter. These buttons enable the user to navigate and select the various menu options.

The menu can include options that are compliant with Digital Living Network Alliance (DNLA) guidelines. The menu Can also support Over-the-Air (OTA) programming, which uses wireless distribution mechanisms for updating device functionality.

Enabling Devices

A secondary device can be enabled for operation with the interface as follows. If the interface 120 detects an input signal at an unassigned input port 105, the interface enters a menu mode to assign the port to the device, and to configure the interface for the commands for the remote controller associated with the device. Similarly, if the interface detects a new IR code, then the interface can enter a menu mode to “learn” the command.

Switching Input Among Devices

The interface 120 can switch the input port to the connected secondary device when an IR command is sensed from the remote controller associated with that device. For example, if the user presses the play button of the remote controller for the DVD device, the audio and video input is connected to the DVD device. If the user later presses a button on the VCR device, then the input is switched accordingly.

Picture-In-Picture

When the TV is displaying the input from one of the connected devices, in other words not displaying the TV menu, a setup screen, or an over-the-air guide, pressing the enter key on the minimal remote controller activates or deactivates a picture-in-picture (PiP) feature. The (PiP) feature displays one program (input1) on the full TV screen (foreground) at the same time as one or more other input is displayed in an inset window (background). Audio is usually from the foreground input. Pressing the left or right keys switches between the foreground and background pictures. The IR remote controller commands maps to the foreground input, so that when a device is turned on or a connected device's remote controller is used, it controls the foreground.

Television Menu

The remote controller 200, as described above, can operate the menu for the primary device, e.g., the television 110. It should be noted that this menu can have menu options for any of the connected secondary devices.

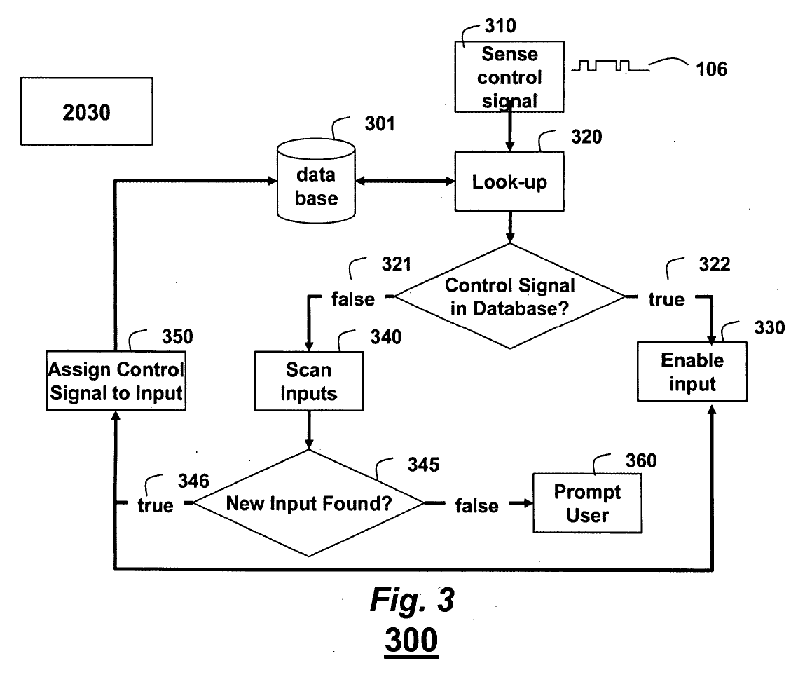

FIG. 3 shows the method for interfacing remote controllers according to the embodiments of the invention. The control signal 106 is sensed 310 by the interface 120. A look-up 320 in a database 301 is performed to determine if the code and an associated secondary device is stored in the database.

If true 322, the interface 101 enables 330 the input port associated with the secondary device.

If false 321, the interface scans 340 the all the input ports for a previously unobserved input signal to determine if a new input is found 345. If true 346 and a previously unobserved input signal is found, then this previously unknown control signal is added to the database and associated with this input and this input is enabled by assigning 350 the control signal to this input. If false 347, then the result of the scanning of inputs is that no new input signal was found, and the interface 120 prompts 360 the user with a graphical user interface that allows the user to associate the unknown control signal with a secondary device.

In another embodiment of the invention, the control signals stored in the database 301 are associated not only with an input on the primary device, but also with one or more commands that the primary device executes upon sensing 310 the control signal 106. For example, the control signal produced by pressing the volume key 220 on the remote control for a cablebox (a secondary device) enables 330 the input associated with the cablebox 330, but also performs the appropriate volume command for the primary device.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

I claim:

1. An apparatus for interfacing consumer devices and wireless remote controllers, comprising:
a remote controller interface, wherein the remote controller interface is configured to sense and process wireless control signals received from a set of secondary remote controllers associated with a set of secondary consumer devices and there is one secondary remote controller for each secondary consumer device, configured to enable input from any of the secondary consumer devices to the primary consumer device in response to sensing the wireless control signals.

2. The apparatus of claim 1, wherein the primary consumer device is a television, and the secondary devices are multimedia playback devices.

3. The apparatus of claim 1, wherein the secondary remote controllers are incompatible with each other.

4. The apparatus of claim 1, wherein the remote controller interface is configured to learn and the wireless control signals from any of the secondary remote controllers.

5. The apparatus of claim 1, wherein the remote controller interface further comprises:
a set of input ports, there being one input port for each secondary consumer device, and wherein a presence or absence of data or control signals are sensed at the set of input ports.

6. The apparatus of claim 5, wherein the data can include audio and video signals.

7. The apparatus of claim 1, wherein a single cable connects the apparatus to the primary consumer device.

8. The apparatus of claim 1, wherein control buttons of a particular remote controller consists of:
a power button;
a volume button;
a menu button; and
menu control buttons.

9. The apparatus of claim 8, wherein the menu control buttons consist of:
up, down, left, right and enter buttons.

10. The apparatus of claim 1, further comprising:
a database for storing the control signal and associated operations.

11. A method for interfacing consumer devices and wireless remote controllers, comprising:
sensing wire control signals from a set of secondary remote controllers associated with a set of secondary consumer devices in a remote controller interface; and
enabling, in the remote controller interface, input from any of the secondary consumer devices to the primary consumer device in response to sensing the wireless control signals.
